(19) United States
(12) Patent Application Publication
(10) Pub. No.: US 2024/0374072 A1
(43) Pub. Date: Nov. 14, 2024

(54) APPLIANCE TO HEAT A LIQUID

(71) Applicant: Breville Pty Limited, Alexandria, NSW (AU)

(72) Inventors: Stephen John MCCLEAN, Alexandria, NSW (AU); Duncan Bruce HELLMERS, Alexandria, NSW (AU); Johnson THIE, Alexandria, NSW (AU)

(21) Appl. No.: 18/555,916

(22) PCT Filed: Apr. 20, 2022
(86) PCT No.: PCT/AU2022/050357

§ 371 Date: Oct. 18, 2023

(30) Foreign Application Priority Data
Apr. 20, 2021 (AU) 2021901163

(51) Int. Cl. A47J 27/21

(52) U.S. Cl. CPC A47J 27/21166; A47J 27/2105

(57) ABSTRACT

There is disclosed herein an appliance to heat a liquid, the appliance including: a vessel to receive the liquid to be heated, the vessel having a base, and a side wall extending upwardly from the base, with the base and side wall at least partly enclosing a chamber within which the liquid is heated; and a heating element for conductive heating of the base and the liquid in the chamber, wherein the base includes a floor and a raised portion extending from the floor into the chamber, the floor having a major surface to contact the liquid, and the raised portion having at least one minor surface to contact the liquid, the at least one minor surface being inclined relative to the major surface to promote movement of one or more bubbles, formed by heating of the liquid, away from the floor and into the chamber.

### FIELD

The present invention relates to appliances to heat liquids, and more particularly, but not exclusively to electrically operated jugs and kettles.

### BACKGROUND

Kettles are well-known devices to rapidly boil water for, for example, making tea, cooking, or the like. A disadvantage of presently known kettles is that as water is heated by a heating element, a small quantity of water close to the heating element is heated to above its boiling point. The quantity of water changes phase to steam and collects as a steam bubble at a steam bubble nucleation site, usually a surface imperfection. As the steam bubble has a lower density than water, the steam bubble rises due to buoyancy. As the steam bubble rises, the temperature of the surrounding water is below boiling temperature, causing the steam bubble to also cool down below boiling temperature. As the steam bubble bursts or cavitates, significant sound waves are created. The noise caused by the cavitation is undesirable in a home environment. Also, it is difficult to spread the heat over a kettle surface with a tube heating element of the kind used in a variety of kettles. Therefore, water adjacent the tube heating element tends to heat up faster as opposed to water away from it, creating an imbalance in temperature and magnifying the cavitation. Known kettles are also prone to undesirable limescale deposition on the surface of the heating plate.

### SUMMARY

It is an object of the present invention to substantially overcome, or at least ameliorate, one or more of the disadvantages of existing arrangements, or at least provide a useful alternative to existing arrangements.

There is disclosed herein an appliance to heat a liquid, the appliance including:
a vessel to receive the liquid to be heated, the vessel having a base, and a side wall extending upwardly from the base, with the base and side wall at least partly enclosing a chamber within which the liquid is heated; and
a heating element for conductive heating of the base and the liquid in the chamber, wherein
the base includes a floor and a raised portion extending from the floor into the chamber,
the floor having a major surface to contact the liquid, and the raised portion having at least one minor surface to contact the liquid, the at least one minor surface being inclined relative to the major surface to promote movement of one or more bubbles, formed by heating of the liquid, away from the floor and into the chamber.

Preferably, the minor surface is continuous with and extends from the major surface towards an extremity of the raised portion.

Preferably, the vessel has a longitudinal axis extending upwards during use of the appliance, and the raised portion provides a pair of minor surfaces having an axis of symmetry passing through the extremity and extending parallel with the longitudinal axis.

Preferably, each of the minor surfaces provides a slope, with the magnitude of the slopes being equal.

Preferably, an angle of intersection between the slopes of the minor surfaces is in a predetermined range to minimise noise generated by the appliance during operation of the appliance. Preferably, the angle is in the range of about 45 degrees to 100 degrees.

Preferably, a void is formed beneath the raised portion, with the heating element being at least partially located within the void.

Preferably, the base has an underside providing a mating surface formed beneath the raised portion to at least partially surround the void, with the mating surface being profiled for complementary engagement with the heating element to maximise thermal communication between the heating element and the raised portion.

Preferably, the base is partially deformed in a direction parallel to the longitudinal axis to form the raised portion.

Preferably, the major surface and each of the minor surfaces are coated to reduce a coefficient of friction between the surfaces and the liquid.

Preferably, the coating resists formation of scale deposits.

Preferably, the base is made of aluminium.

### BRIEF DESCRIPTION OF THE DRAWINGS

Exemplary embodiments of the present disclosure will now be described, by way of examples only, with reference to the accompanying description and drawings in which:

FIG. 1 is a vertically cross-sectioned front view of a kettle according to an embodiment of the present invention;

FIG. 2 is an enlarged detail view of portion A of the kettle of FIG. 1, showing a base and a heating element of the kettle;

FIG. 3 is a simplified schematic vertically cross-sectioned front view of an existing kettle showing bubble formation;

FIG. 4 is a simplified schematic view of the base and element of FIG. 2, showing bubble formation;

FIG. 5 is a simplified schematic view of the base and element of FIG. 2;

FIG. 6 is a top perspective view of the base of the kettle of FIG. 1;

FIG. 7 is a side view of the base of FIG. 6; and

FIG. 8 is a bottom perspective view of the base of FIG. 6.

### DESCRIPTION OF EMBODIMENTS

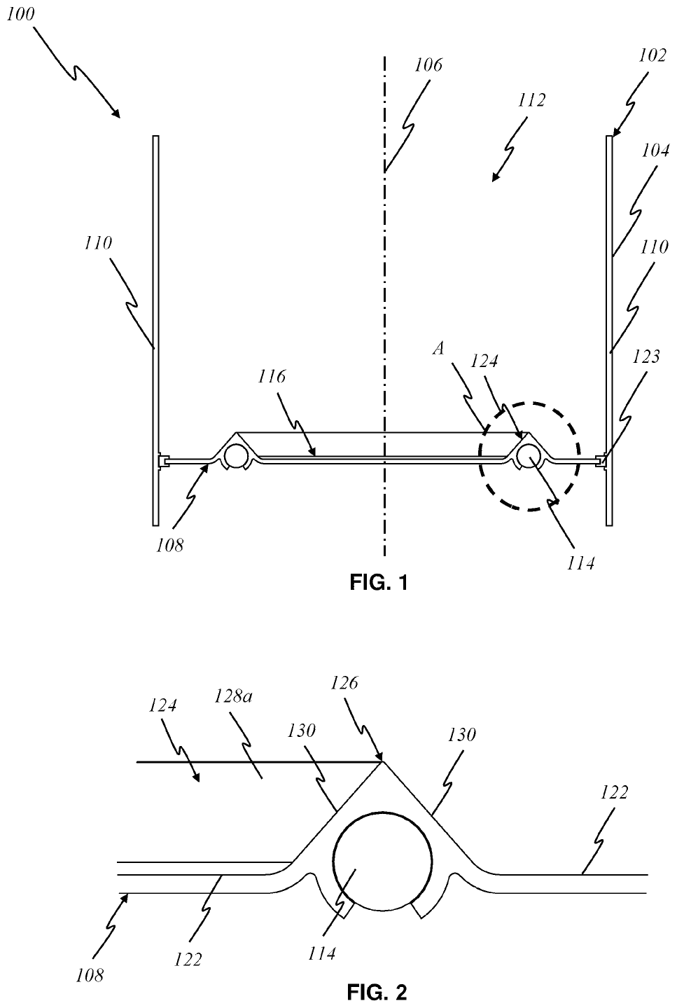

Referring firstly to FIG. 1 of the accompanying drawings, there is depicted an appliance to heat a liquid. Preferably, the appliance is a kettle 100 to heat liquid water. The kettle 100 includes a vessel or jug 102 to receive the water to be heated. The kettle 100 also includes a jug stand or heater bottom (not shown) upon which the jug 102 rests.

The jug 102 includes a hollow body 104 providing a generally central upright longitudinal axis 106. The body 104 includes a generally circular base 108 and a side wall 110 extending upwardly from the base 108. The base 108 and side wall 110 partly enclose a chamber 112 within which the water is heated. The base 108 is preferably in the form of a metallic plate, preferably made of aluminium.

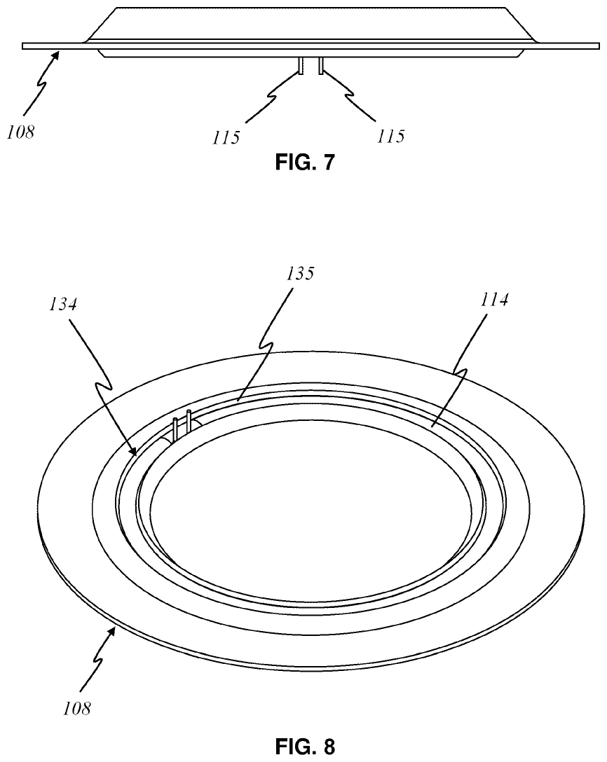

To heat the water in the chamber 112, the kettle 100 includes a heating element 114 electrically coupled via electrical terminals 115 (FIG. 7) to a power supply module (not shown) housed with the heater bottom when the jug 102 is resting on the heater bottom. The power supply module is configured to supply power to the element 114 to resistively heat the element 114. The element 114 is in thermal communication with the base 108 and the chamber 112 so that heat generated by the element 114 can be delivered through the base 108 to the water in the chamber 112 via conduction. In the embodiment depicted, the element 114 has a circular cross-section which is revolved around the axis 106 to form a generally toroidal configuration of the element 114. In other embodiments, the element 114 may have a square or other polygonal cross-section forming different revolved configurations relative to the axis 106.

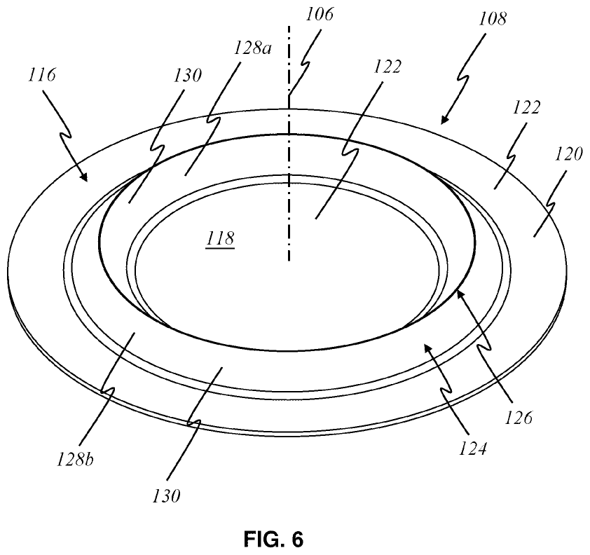

In the embodiment depicted, the base 108 provides a generally planar or flat floor 116 of the jug 102 extending radially outwardly from the axis 106. As shown in FIG. 6, the floor 116 includes an inner circular region 118 and an outer annular region 120 radially spaced from the inner circular region 118 relative to the axis 106. Together, the inner circular region 118 and the outer annular region 120 provide a major surface 122 of the floor 116 configured to contact the water in the chamber 112 to be heated. The outer annular region 120 sealingly engages the side wall 110 of the jug 102 via a silicone seal 123 (FIG. 1).

In the embodiment depicted, the base 108 is partially deformed at a radial location between the inner circular region 118 and the outer annular region 120 in a direction parallel to the axis 106 to form a raised portion 124. The raised portion 124 circumferentially extends between the inner circular region 118 and the outer annular region 120 with respect to the axis 106 and is integral with the floor 116. In other embodiments, the raised portion 124 may be a separate component to the floor 116 and fixed to the floor 116 by standard fixing techniques.

As shown in FIG. 2, the raised portion 124 extends upwardly into the chamber 112 terminating in a peak, apex or extremity 126 spaced upwardly from the major surface 122. The extremity 126 preferably has a radius of curvature of between about 0 mm to 4 mm.

As shown in FIG. 6, the raised portion 124 provides a pair of inner and outer side walls 128a, 128b, respectively. Each side wall 128a, 128b has a minor surface 130 which is angled or inclined relative to the major surface 122 of the floor 116. The minor surface 130 of the inner side wall 128a is inclined away from the axis 106 whilst the minor surface 130 of the outer side wall 128b is inclined toward the axis 106. The minor surfaces 130 are continuous with and extend from the major surface 122 towards the extremity 126 of the raised portion 124. In the embodiment depicted, each of the minor surfaces 130 are formed by revolving a generally linear curve around the axis 106. In other embodiments, the curve may not be linear but may be another two-dimensional curve to form a different revolved surface profile of the minor surfaces 130. For example, the pair of minor surfaces 130 may be replaced by one minor surface formed by revolving an arc or semi-circle around the axis 106 to form a domed-surface profile of the raised portion 124.

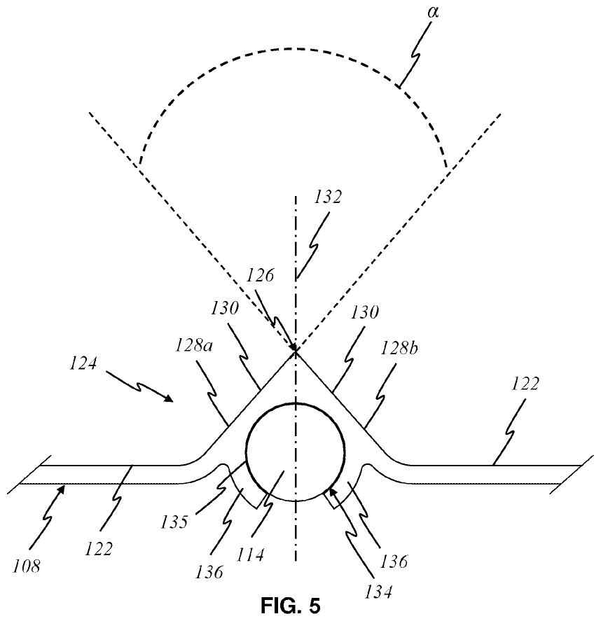

As shown in FIG. 5, the side walls 128a, 128b have a vertical axis of symmetry 132 passing through the extremity 126 and extending parallel with the axis 106 such that the magnitude of the slopes or ramps of the minor surfaces 130 are equal. An angle α of intersection between the slopes of the minor surfaces 130 is within a predetermined range which reduces noise level (typically measured in decibels, dB) of the kettle 100. The angle α is between a maximum and a minimum predetermined value to allow for i) a sufficient space for locating the heating element 114; and ii) scope for forming bubbles and cavitating bubbles at or above the extremity 126. Preferably, the angle α is in the range of about 45 degrees to 100 degrees.

During a heating operation of the kettle 100, less larger bubbles may be formed, and bubbles may burst at a location close to the floor 116 if the angle α is outside the predetermined range, causing a relatively larger number of bubbles transit soundwaves to a relatively large surface area (i.e. the floor 116). If the angle α is larger than a maximum value, the slopes or ramps of the minor surfaces 130 may be insufficiently steep for the bubbles to slide upwards to the extremity 126 and instead may cavitate on the minor surfaces 130 instead of at or above the extremity 126, resulting in more noise generated. If the angle α is less than a minimum value (i.e. a steep scope), the bubbles may burst before forming larger bubbles and, additionally, there may not be sufficient space for the heating element 114 to be located beneath the minor surfaces 130 as will be discussed below.

With particular reference to FIGS. 5 and 8, a space or void 134 is provided beneath the raised portion 124 to house or locate the heating element 114. Partially surrounding the void 134 is a mating surface 135 formed along an underside of the base 108. In the embodiment depicted, the mating surface 135 has a circular cross-section to complement the profile of the element 114 so that the element 114 is in direct complementary engagement or contact with the side walls 128a, 128b to maximise heat transfer efficiency between the element 114 and the base 108. The raised portion 124 further includes a pair of retaining arms 136 extending on the underside of the base 108. Each arm 136 is integrally formed with and extends from a respective one of the side walls 128a, 128b. Each arm 136 is curved to complement the circular profile of the element 114 such that the arms 136 are in supporting conformity with the element 114 to further maximise heat transfer efficiency between the element 114 and the base 108. In this way, the arms 136 may be pressed or crimped onto the element 114 to securely hold the element 114 and base 108 together. In other embodiments, the element 114 may be interposed between the base 108 and a secondary plate (not shown) which is appropriately shaped to complement the profile of the element 114. It will be appreciated that dimensions of the side walls 128a, 128b and the angle α may be varied depending on the diameter of the element 114 to retain function and efficiency.

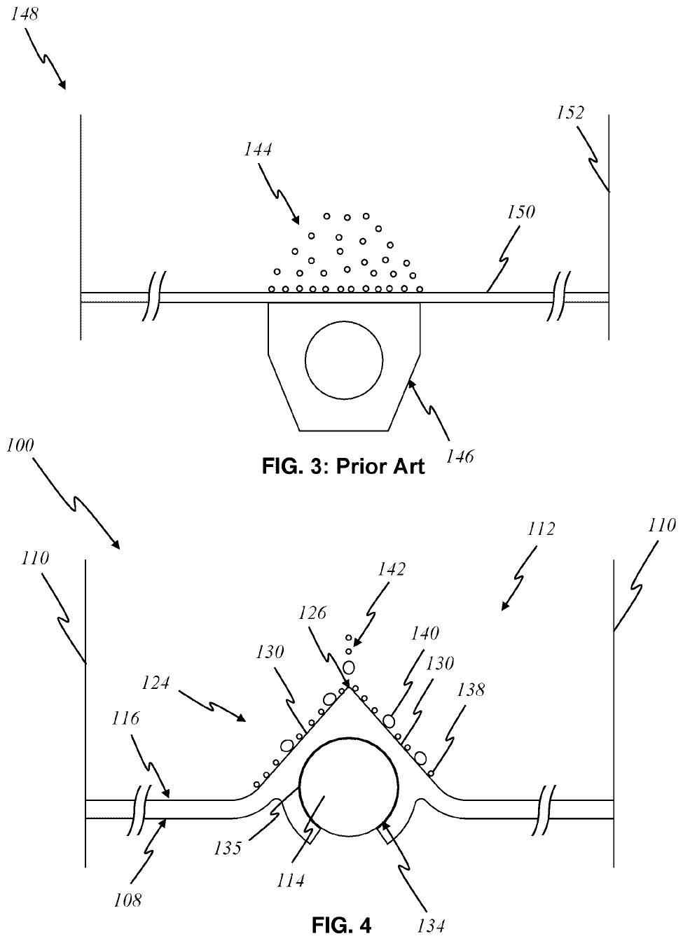

As shown in FIG. 4, during operation of the kettle 100, vapour molecules or bubbles 138 form at nucleation sites due to cavitation of the water adjacent the minor surfaces 130. By virtue of the geometrical profile of the raised portion 124, the minor surfaces 130 are configured to act as ramps to promote or guide the bubbles 138 to move towards the extremity 126 where the bubbles 138 dissociate from the extremity 126 and rise into the chamber 112 forming a generally linear bubble trail 142. This is distinct to the generally spread apart bubble formation 144 produced by a standard element configuration 146 in an existing kettle 148 as illustrated in FIG. 3, for example.

In the existing kettle 148 as illustrated in FIG. 3, a significant level of noise is generated as a relatively large number of bubbles transmit soundwaves to a relatively large surface area (that is, the floor 150 and the side wall 152 of the kettle 148). In contrast, the kettle 100 reduces the total number of bubbles formed by virtue of the inclined minor surfaces 130 which cause the bubbles 138 to slide upwards away from the floor 116 as they gain buoyancy before lifting off the base 108 at the extremity 126. The upwards sliding motion of the bubbles 138 causes the bubbles 138 to contact and join with adjacent bubbles 138, creating fewer but larger bubbles 140. In the kettle 100, the intensity of the soundwaves transmitted to the floor 116 is reduced compared to the existing kettle 148 since the bubbles 138 burst at a higher location from the floor 116. These fewer larger bubbles 140 lifting off the base 108 at the extremity 126 results in less vibration transmitted to the base 108 which leads to less noise overall as the bubbles 138, 140 cavitate. This is because the vertical distance from a location where the bubbles 138, 140 burst to the floor 116 is increased. The inclined minor surfaces 130 also provide less surface area to receive the soundwaves directly.

By locating the element 114 in the void 134, a greater contact surface area between the element 114 and the base 108 can be achieved thus improving the efficiency of the kettle 100, resulting in a faster boil and a more even heat distribution when compared to existing kettles (such as the kettle 148) of the same wattage. This in turn reduces the noise level of the kettle 100.

The major surface 122 and/or the minor surfaces 130 are preferably coated with a non-stick or low friction coating to reduce the coefficient of friction between the surfaces 122, 130 and the water in the chamber 112 to facilitate motion of the bubbles 138, 140 along the minor surfaces 130 to reduce noise. The non-stick coating also facilitates removal of limescale deposition by inhibiting or resisting formation of scale deposits on the surfaces 122, 130.

Experimental data of the kettle 100 demonstrates that a noise reduction between 15 dB and 20 dB when compared to existing kettles can be achieved. When applying the same input power, the boil time is also significantly reduced (30 seconds) when compared to existing kettles.

### REFERENCE LIST

100 Kettle
102 Jug
104 Body
106 Longitudinal axis
108 Base
110 Side wall of jug
112 Chamber
114 Heating element
115 Electrical terminals
116 Floor
118 Inner circular region
120 Outer annular region
122 Major surface
123 Silicone seal
124 Raised portion
126 Extremity
128a,b Side walls of raised portion
130 Minor surface
132 Axis of symmetry
134 Void
135 Mating surface
136 Retaining arms
138 Bubbles
140 Larger bubbles
142 Bubble trail
144 Bubble formation
146 Standard element configuration
148 Existing kettle
150 Floor of conventional kettle
152 Side wall of convention kettle

1. An appliance to heat a liquid, the appliance including:
a vessel to receive the liquid to be heated, the vessel having a base, and a side wall extending upwardly from the base, with the base and side wall at least partly enclosing a chamber within which the liquid is heated; and
a heating element for conductive heating of the base and the liquid in the chamber, wherein
the base includes a floor and a raised portion extending from the floor into the chamber,
the floor having a major surface to contact the liquid, and the raised portion having at least one minor surface to contact the liquid, the at least one minor surface being inclined relative to the major surface to promote movement of one or more bubbles, formed by heating of the liquid, away from the floor and into the chamber.

2. The appliance of claim 1, wherein the minor surface is continuous with and extends from the major surface towards an extremity of the raised portion.

3. The appliance of claim 2, wherein the vessel has a longitudinal axis extending upwards during use of the appliance, and the raised portion provides a pair of minor surfaces having an axis of symmetry passing through the extremity and extending parallel with the longitudinal axis.

4. The appliance of claim 3, wherein each of the minor surfaces provides a slope, with the magnitude of the slopes being equal.

5. The appliance of claim 4, wherein an angle of intersection between the slopes of the minor surfaces is in a predetermined range to minimise noise generated by the appliance during operation of the appliance.

6. The appliance of claim 5, wherein the angle is in the range of about 45 degrees to 100 degrees.

7. The appliance of claim 1, wherein a void is formed beneath the raised portion, with the heating element being at least partially located within the void.

8. The appliance of claim 7, wherein the base has an underside providing a mating surface formed beneath the raised portion to at least partially surround the void, with the mating surface being profiled for complementary engagement with the heating element to maximise thermal communication between the heating element and the raised portion.

9. The appliance of claim 1, wherein the base is partially deformed in a direction parallel to the longitudinal axis to form the raised portion.

10. The appliance of claim 1, wherein the major surface and each of the minor surfaces are coated to reduce a coefficient of friction between the surfaces and the liquid.

11. The appliance of claim 10, wherein the coating resists formation of scale deposits.

12. The appliance of claim 1, wherein the base is made of aluminium.
